(19) United States
(12) Patent Application Publication
(10) Pub. No.: US 2026/0118605 A1
(43) Pub. Date: Apr. 30, 2026

(54) OPTICAL-ELECTRICAL INTEGRATED DEVICE

(71) Applicant: SHINKO ELECTRIC INDUSTRIES CO., LTD., Nagano (JP)

(72) Inventors: Yuji FURUTA, Nagano (JP); Hisashi KANEDA, Nagano (JP); Tomoharu FUJII, Nagano (JP)

(21) Appl. No.: 19/370,303

(22) Filed: Oct. 27, 2025

(30) Foreign Application Priority Data
Oct. 30, 2024 (JP) 2024-190648

(51) Int. Cl. G02B 6/42

(52) U.S. Cl. CPC G02B 6/4239; G02B 6/4238; G02B 6/4243; G02B 6/4245

(57) ABSTRACT

An optical-electrical integrated device includes a wiring board having a first insulating layer that includes a resin as a main component, and an interconnect layer disposed on the first insulating layer and including a pad, a photonic integrated circuit disposed on the first insulating layer and electrically connected to the pad, an optical fiber disposed on the first insulating layer and configured to transmit and receive an optical signal to and from the photonic integrated circuit, and a fixing member made of glass, disposed on the first insulating layer, and configured to clamp the optical fiber between the first insulating layer and the fixing member.

### CROSS-REFERENCE TO RELATED APPLICATIONS

This application is based upon and claims priority to Japanese Patent Application No. 2024-190648, filed on Oct. 30, 2024, the entire contents of which are incorporated herein by reference.

### FIELD

Certain aspects of the embodiments discussed herein are related to optical-electrical integrated devices. The optical-electrical integrated devices are sometimes also referred to as optoelectronic hybrid modules.

### BACKGROUND

In a data center or the like where various computers and devices for data communication or the like are installed, an optical coupling structure for connecting an optical waveguide device and an optical fiber or the like may be used. An example of such an optical coupling structure includes an optical coupling component using a planar lightwave circuit that is bonded and fixed to end surfaces of input/output waveguides of the optical waveguide device, and the optical waveguide device and the optical fiber are optically coupled via the planar lightwave circuit, as proposed in Japanese Laid-Open Patent Publication No. 2020-64211, for example.

In the optical coupling structure described above, the optical waveguide device and the optical coupling component are bonded and fixed to each other via a small bonding area, and thus, a bonding or adhesive strength between the optical waveguide device and the optical coupling component is weak. For this reason, when stress is applied to a coupling part between the optical waveguide device and the optical coupling component, a fracture may occur between the optical waveguide device and the optical coupling component, and a reliability of the optical coupling may deteriorate.

### SUMMARY

Accordingly, it is an object in one aspect of the embodiments to provide an optical-electrical integrated device having an optical coupling structure with a high reliability of optical coupling.

According to one aspect of the embodiments, an optical-electrical integrated device includes a wiring board having a first insulating layer that includes a resin as a main component, and an interconnect layer disposed on the first insulating layer and including a pad; a photonic integrated circuit disposed on the first insulating layer and electrically connected to the pad; an optical fiber disposed on the first insulating layer and configured to transmit and receive an optical signal to and from the photonic integrated circuit; and a fixing member made of glass, disposed on the first insulating layer, and configured to clamp the optical fiber between the first insulating layer and the fixing member.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a plan view illustrating an example of an optical-electrical integrated device according to a first embodiment;

FIG. 2 is a cross sectional view (part 1) illustrating the example of the optical-electrical integrated device according to the first embodiment;

FIG. 3 is a cross sectional view (part 2) illustrating example of the optical-electrical integrated device according to the first embodiment; and

FIG. 4 is a cross sectional view illustrating an example of the optical-electrical integrated device according to a first modification of the first embodiment.

### DESCRIPTION OF EMBODIMENTS

Hereinafter, embodiments of the present disclosure will be described with reference to the accompanying drawings. In the drawings, the same constituent elements or components are designated by the same reference numerals, and a redundant description thereof may be omitted.

### First Embodiment

### [Structure of Optical-Electrical Integrated Device]

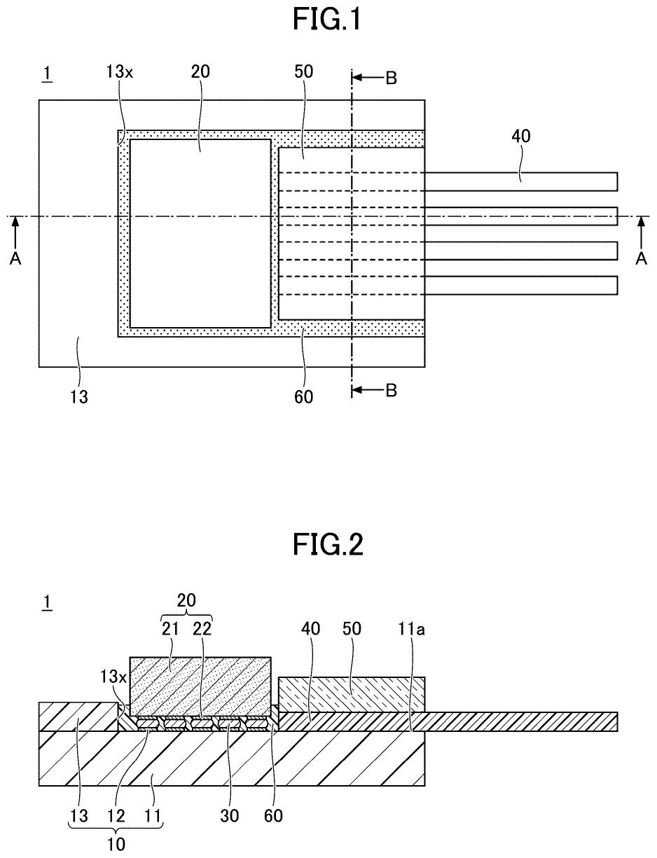

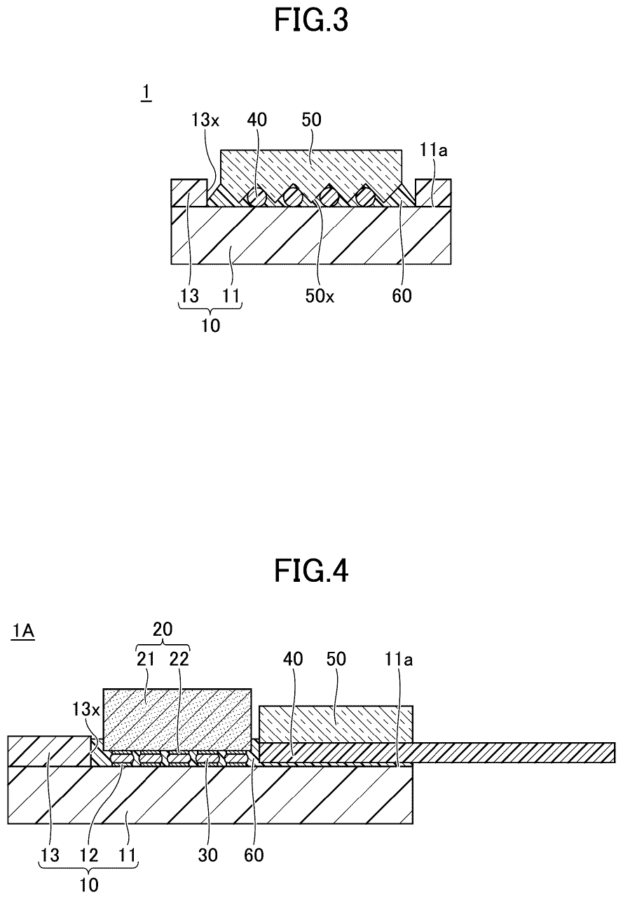

FIG. 1 is a plan view illustrating an example of an optical-electrical integrated device according to a first embodiment. FIG. 2 is a cross sectional view illustrating the example of the optical-electrical integrated device according to the first embodiment, and illustrates a cross section taken along a line A-A in FIG. 1. FIG. 3 is a cross sectional view illustrating the example of the optical-electrical integrated device according to the first embodiment, and illustrates a cross section taken along a line B-B in FIG. 1.

As illustrated in FIG. 1, FIG. 2, and FIG. 3, an optical-electrical integrated device 1 includes a wiring board 10, a photonic integrated circuit (PIC) 20, an optical fiber 40, and a fixing member 50. The optical-electrical integrated device 1 may further include a bonding material 30 and a resin part 60.

The wiring board 10 has a first insulating layer 11, an interconnect layer 12, and a second insulating layer 13. The wiring board 10 may have one or more electronic components electrically connected to the interconnect layer 12. The electronic components include passive components and active components. Examples of the active components include semiconductor devices having a function of amplifying an electrical signal input from the photonic integrated circuit 20, for example.

A material used for the first insulating layer 11 is an insulating resin including an epoxy-based resin, a polyimide-based resin, or the like as a main component. The first insulating layer 11 may include a reinforcing member, such as a glass cloth or the like. The first insulating layer 11 may include a filler, such as silica (SiO₂) or the like. A thickness of the first insulating layer 11 may be approximately 15 μm to approximately 35 μm, for example. The first insulating layer 11 is an insulating layer constituting a build-up substrate, for example. In this case, one or more arbitrary layers, such as an interconnect layer, an insulating layer, a core layer, or the like, may be disposed under the first insulating layer 11. In addition, the interconnect layer 12 may be electrically connected to the interconnect layer disposed under the first insulating layer 11, through a via interconnect provided in the first insulating layer 11.

The interconnect layer 12 is provided on an upper surface 11a of the first insulating layer 11. The interconnect layer 12 may be provided so that a lower surface and a side surface of the interconnect layer 12 are embedded in the first insulating layer 11 and an upper surface of the interconnect layer 12 is exposed from the upper surface 11a of the first insulating layer 11. The interconnect layer 12 includes pads and one or more interconnect patterns. A material used for the interconnect layer 12 may be copper (Cu) or the like, for example. A thickness of the interconnect layer 12 is approximately 10 μm to approximately 40 μm, for example.

If required, a metal layer may be formed on upper surfaces of the pads constituting the interconnect layer 12, or an anti-oxidation treatment, such as an organic solderability preservative (OSP) treatment or the like, may be performed on the upper surfaces of the pads constituting the interconnect layer 12. Examples of the metal layer include a gold (Au) layer, a nickel/gold (Ni/Au) layer (a metal layer in which a Ni layer and a Au layer are stacked in this order), a nickel/palladium/gold (Ni/Pd/Au) layer (a metal layer in which a Ni layer, a Pd layer, and a Au layer are stacked in this order), or the like.

The second insulating layer 13 is disposed on the first insulating layer 11. The second insulating layer 13 is a so-called solder resist layer. The second insulating layer 13 has openings 13x exposing portions of the upper surface 11a of the first insulating layer 11 and the pads constituting the interconnect layer 12. A material used for the second insulating layer 13 is an insulating resin including a photosensitive epoxy-based resin, a photosensitive polyimide-based resin, or the like as a main component. A thickness of the second insulating layer 13 is approximately 15 μm to approximately 35 μm, for example.

The photonic integrated circuit 20 includes a main body 21 and electrodes 22. The main body 21 is a substrate made of silicon or the like and having a plurality of optical waveguides, light emitting elements, light receiving elements, or the like provided on the substrate, for example. The electrodes 22 are connection terminals formed of gold bumps, solder bumps, copper posts with solder provided on tip ends thereof, or the like, for example. The electrodes 22 are disposed on one surface of the main body 21. The optical waveguides and the electrodes 22 are disposed on the same surface side of the main body 21.

The photonic integrated circuit 20 may be referred to as silicon photonics or the like. The photonic integrated circuit 20 can have a function of converting an optical signal input from the optical fiber 40 into an electrical signal and/or a function of converting an input electrical signal into an optical signal and outputting the optical signal to the optical fiber 40.

The photonic integrated circuit 20 is disposed on the first insulating layer 11 exposed inside the opening 13x, and is electrically connected to the pads constituting the interconnect layer 12. Specifically, the photonic integrated circuit 20 is flip-chip mounted face-down on the upper surface 11a of the first insulating layer 11. That is, the electrodes 22 of the photonic integrated circuit 20 are bonded to the pads constituting the interconnect layer 12 via the conductive bonding material 30, such as solder or the like.

The optical fiber 40 is disposed on the first insulating layer 11 exposed inside the opening 13x, adjacent to the photonic integrated circuit 20. The number of the optical fibers 40 provided may be an arbitrary number that is one or more. In the illustrated example, four optical fibers 40 are arranged in parallel at predetermined intervals. The optical fibers 40 extend to the outside of the first insulating layer 11 across one side of the upper surface 11a of the first insulating layer 11 in the plan view. That is, the opening 13x reaches the one side of the upper surface 11a of the first insulating layer 11. In other words, the second insulating layer 13 located around the opening 13x does not have a picture-frame shape in the plan view, and second insulating layer 13 has a shape that is open in one direction. Hence, the optical fibers 40 can extend to the outside of the first insulating layer 11 across the one side of the upper surface 11a of the first insulating layer 11 exposed inside the opening 13x in the plan view.

A gap between each optical fiber 40 and the photonic integrated circuit 20 is approximately several tens of micrometers, for example. An end of each optical waveguide of the photonic integrated circuit 20 faces an end of each optical fiber 40. For this reason, each optical waveguide of the photonic integrated circuit 20 can transmit and receive an optical signal to and from each optical fiber 40. A bonding material may be disposed in the gap between each optical fiber 40 and the photonic integrated circuit 20. For example, an optical adhesive having a good transmittance with respect to wavelengths of the optical signal transmitted and received between the optical fibers 40 and the photonic integrated circuit 20 can be used for the bonding material disposed in the gap between each optical fiber 40 and the photonic integrated circuit 20.

The fixing member 50 is disposed on the first insulating layer 11 exposed inside the opening 13x, and clamps (or holds) the optical fibers 40 between the first insulating layer 11 and the fixing member 50. The fixing member 50 is made of glass, for example. The fixing member 50 has grooves 50x having an elongated shape in a surface of the fixing member 50 facing the upper surface 11a of the first insulating layer 11. For example, the grooves 50x have a V shape in a cross section cut perpendicularly to a longitudinal direction of the grooves 50x. The cross section of the grooves 50x cut perpendicularly to the longitudinal direction of the grooves 50x may have a shape other than the V shape, such as a U shape or the like. The optical fibers 40 are in contact with the upper surface 11a of the first insulating layer 11 and inner walls of the grooves 50x. Thus, the optical fibers 40 are held between the first insulating layer 11 and the fixing member 50.

The resin part 60 is located on the upper surface 11a of the first insulating layer 11 exposed inside the opening 13x. The resin part 60 is located at least around the bonding material 30 between the photonic integrated circuit 20 and the upper surface 11a of the first insulating layer 11, and around the optical fibers 40 between the inner walls of the grooves 50x and the upper surface 11a of the first insulating layer 11. Accordingly, it is possible to improve a reliability of optical coupling between the photonic integrated circuit 20 and the first insulating layer 11, and bond the fixing member 50 to the first insulating layer 11.

When forming the resin part 60, a liquid resin is coated inside the opening 13x of the second insulating layer 13 in a state where the resin part 60 illustrated in FIG. 1 and FIG. 2 is not yet provided. The liquid resin is coated around the bonding material 30 between the photonic integrated circuit 20 and the upper surface 11a of the first insulating layer 11, and around the optical fibers 40 between the inner walls of the grooves 50x and the upper surface 11a of the first insulating layer 11, by causing the liquid resin to flow to these locations, for example. The coated liquid resin is thereafter cured in this state to form the resin part 60 illustrated in FIG. 1 and FIG. 2. When the liquid resin flows, an inner wall surface of the second insulating layer 13 defining the opening 13x can block the flow of the liquid resin to prevent the liquid resin from flowing to unwanted locations.

A material having a good flowability is preferably used for the resin part 60 because the material needs to flow into narrow spaces. The material used for the resin part 60 may be an insulating resin, such as an epoxy-based resin or the like, for example.

As described above, in the optical-electrical integrated device 1, an interface (or optical coupling section) between the photonic integrated circuit 20 and the optical fiber 40 is located on the first insulating layer 11. In addition, the optical fibers 40 are clamped between the first insulating layer 11 and the fixing member 50. Accordingly, unlike a structure in which an interface between two members is located outside a substrate in the plan view as in the related art, stress is less likely to concentrate at the interface between the photonic integrated circuit 20 and the optical fibers 40 in the present embodiment. For this reason, it is possible to reduce a risk of a fracture occurring at the interface between the photonic integrated circuit 20 and the optical fibers 40. That is, an optical coupling structure having a high reliability of optical coupling can be provided between the photonic integrated circuit 20 and the optical fibers 40.

In addition, because the first insulating layer 11 of the optical-electrical integrated device 1 also forms a lower member of the structure that fixes the optical fibers 40, it is possible to reduce a height of the optical-electrical integrated device 1. Moreover, because the first insulating layer 11 of the optical-electrical integrated device 1 forms the lower member of the structure that fixes the optical fibers 40, and the fixing member 50 is disposed on the first insulating layer 11, it is possible to reduce a size of the optical-electrical integrated device 1 along a direction in which the optical fibers 40 extend.

Further, because the optical-electrical integrated device 1 includes the resin part 60, it is possible to increase a strength of the interface between the photonic integrated circuit 20 and the optical fibers 40.

### First Modification of First Embodiment

In a first modification of the first embodiment, an example of the optical-electrical integrated device including the optical fibers that do not make contact with the upper surface of the first insulating layer will be described. FIG. 4 is a cross sectional view illustrating an example of the optical-electrical integrated device according to the first modification of the first embodiment.

As illustrated in FIG. 4, an optical-electrical integrated device 1A differs from the optical-electrical integrated device 1 in that the optical fibers 40 of the optical-electrical integrated device 1A make contact with the resin part 60 located on the upper surface 11a of the first insulating layer 11 and with the inner walls of the grooves 50x of the fixing member 50. The optical fibers 40 of the optical-electrical integrated device 1A do not make contact with the upper surface 11a of the first insulating layer 11. The optical fibers 40 are located around the bonding material 30 between the photonic integrated circuit 20 and the upper surface 11a of the first insulating layer 11, but otherwise, the optical-electrical integrated device 1A has a structure similar to that of the optical-electrical integrated device 1.

As described above, the resin part 60 may be interposed between the optical fibers 40 and the upper surface 11a of the first insulating layer 11. For example, before curing the resin part 60, an active alignment may be performed so that the optical fibers 40 are positioned to optically couple to the optical waveguides of the photonic integrated circuit 20. In this case, by curing the resin part 60 in a state where the optical fibers 40 are positioned with respect to the optical waveguides of the photonic integrated circuit 20 by the active alignment, it is possible to easily align the positions of the optical fibers 40 to the optical waveguides of the photonic integrated circuit 20.

According to the present disclosure, it is possible to provide an optical-electrical integrated device having an optical coupling structure with a high reliability of optical coupling.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical-electrical integrated device comprising:
a wiring board having a first insulating layer that includes a resin as a main component, and an interconnect layer disposed on the first insulating layer and including a pad;
a photonic integrated circuit disposed on the first insulating layer and electrically connected to the pad;
an optical fiber disposed on the first insulating layer and configured to transmit and receive an optical signal to and from the photonic integrated circuit; and
a fixing member made of glass, disposed on the first insulating layer, and configured to clamp the optical fiber between the first insulating layer and the fixing member.

2. The optical-electrical integrated device as claimed in claim 1, wherein:
the fixing member has a surface facing an upper surface of the first insulating layer, and a groove formed in the surface of the fixing member, and
the optical fiber is in contact with the upper surface of the first insulating layer and an inner wall of the groove.

3. The optical-electrical integrated device as claimed in claim 1, wherein:
the fixing member has a surface facing an upper surface of the first insulating layer, and a groove formed in the surface of the fixing member, and
the optical fiber is in contact with a resin part located on the upper surface of the first insulating layer and with an inner wall of the groove.

4. The optical-electrical integrated device as claimed in claim 2, further comprising:
a second insulating layer disposed on the first insulating layer, and having an opening exposing a portion of the upper surface of the first insulating layer and the pad,
wherein the photonic integrated circuit, the optical fiber, and the fixing member are disposed on the first insulating layer exposed inside the opening.

5. The optical-electrical integrated device as claimed in claim 4, further comprising:
a resin part located inside the opening, wherein:
the photonic integrated circuit is bonded to the pad via a conductive bonding material, and
the resin part is located at least around the bonding material between the photonic integrated circuit and the upper surface of the first insulating layer, and around the optical fiber between the inner wall of the groove and the upper surface of the first insulating layer.

6. The optical-electrical integrated device as claimed in claim 3, further comprising:
a second insulating layer disposed on the first insulating layer, and having an opening exposing a portion of the upper surface of the first insulating layer and the pad,
wherein the photonic integrated circuit, the optical fiber, and the fixing member are disposed on the first insulating layer exposed inside the opening.

7. The optical-electrical integrated device as claimed in claim 6, wherein:
the photonic integrated circuit is bonded to the pad via a conductive bonding material, and
the resin part is located around the bonding material between the photonic integrated circuit and the upper surface of the first insulating layer, and around the optical fiber between the inner wall of the groove and the upper surface of the first insulating layer.

8. The optical-electrical integrated device as claimed in claim 4, wherein:
the opening reaches one side of the upper surface of the first insulating layer, and
the optical fiber extends to an outside of the first insulating layer across one side of the upper surface of the first insulating layer exposed inside the opening in a plan view.
